(19) United States
(12) Patent Application Publication
(10) Pub. No.: US 2006/0286215 A1
(43) Pub. Date: Dec. 21, 2006

(54) Container structure

(76) Inventor: Chong Fa Yu, Panchiao City (TW)

Correspondence Address: LIN & ASSOCIATES INTELLECTUAL PROPERTY, P.O. BOX 2339, SARATOGA, CA, 95070-0339, US

(21) Appl. No.: 11/157,593

(22) Filed: Jun. 21, 2005

(51) Int. Cl. A23B 7/148

(52) U.S. Cl. 426/106

(57) ABSTRACT

A container structure includes a container formed as a dish structure, which has a dish bottom that is a bottom of the container and is formed a convex. The convex has a plurality of trench distributed radially and a plurality of grooves surrounded the convex. The convex of the dish bottom has height difference so that liquid flows along the convex into the grooves of the dish bottom. Therefore, some liquid on an upper surface of the convex of the dish bottom flows into the grooves while hydrous food is put on the container. Besides, some other liquid flows into the grooves by guiding of the trenches, and the liquid and food on the container are separated.

### BACKGROUND OF THE INVENTION

1. Field of the Invention

The present invention relates to a container structure, and more particularly to a container structure that provides liquid and food on the container to be separated.

2. Description of Related Art

With the high development of the industry and commerce, people work in the city which has great denseness in population, and the life-style is tense and busy. There are more and more persons take lunch boxes for their staple. Especially at the lunch during the workday, besides going to the restaurant there is nothing but lunch boxes.

The containers related prior arts for lunch boxes usually emphasize the basic function for containing, and these containers are dish-like and have flat bottom. The liquid sauce materials of non-staple foods are always mixed to each other and intermix with the staple foods so that the foods taste bad.

Certainly, there are some containers which have grooves at bottom for separating sauce and foods, but there are some shortcomings still as follows: (1) Users must pour sauce into grooves of a container related prior arts, but they can not gather up the sauce in the grooves while some sauce spill on the bottom of the container. (2) While using the container to eat, the sauced material must be packed separately, but this increases the cost and is inconvenient. (3) Sometimes, the food is greasy or hydrous, and the container cannot separate the food and these liquid things. Therefore, the moist food will be tasted badly and the greasy food will make people unhealthy.

Thus the present invention is aimed to provide a container that overcomes the drawbacks of the prior art, and the container according to the present invention is beneficial for containing sauce and moist or greasy food.

### SUMMARY OF THE INVENTION

An objective of the present invention is to provide a container structure for food to separate liquid on the container.

Another objective of the present invention is to provide a container structure for containing the sauced material and food together but making the sauce and the food separate, and this will keep relish of the food in storage.

In accordance with the present invention, a container structure comprises a container formed as a dish structure, which comprises a dish bottom that is a bottom of the container and is formed a convex. The convex has a plurality of trench distributed radially and a plurality of grooves surrounding the convex. The convex of the dish bottom has height difference so that liquid flows along the convex into the grooves of the dish bottom. Therefore, some liquid on an upper surface of the convex of the dish bottom flows into the grooves while hydrous food is put on the container. Besides, some other liquid flows into the grooves by guiding of the trenches, and the liquid and food on the container are separated.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1 is a perspective view of a first embodiment of a container structure according to the present invention;

FIG. 2 is another perspective view of the container structure of the present invention;

FIG. 3 is a cross-sectional view of the container structure of the present invention;

FIG. 4 is a perspective view of a second embodiment of container structure according to the present invention;

FIG. 5 is a perspective view of a third embodiment of container structure according to the present invention.

### DETAILED DESCRIPTION OF THE PREFFERED EMBODIMENTS

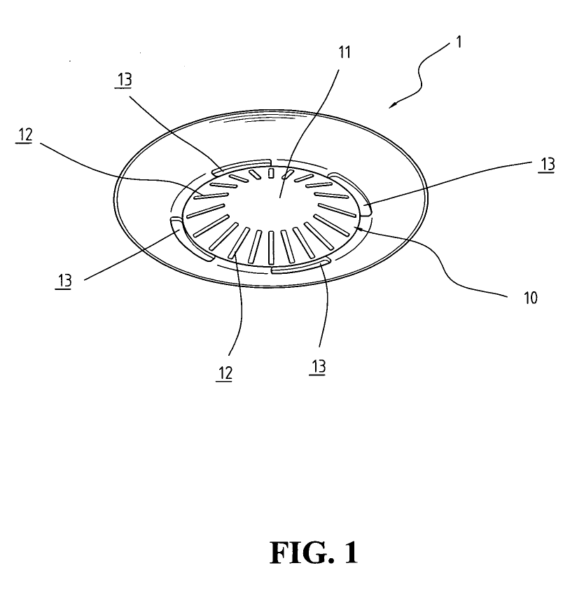

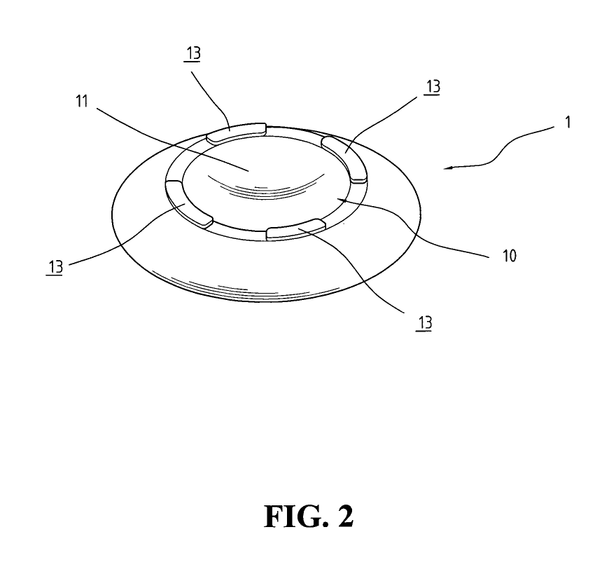

With reference to FIGS. 1-3, a container 1 constructed in accordance with the present invention is formed as a dish structure and has a dish bottom 10 forming a convex 11 which has a plurality of trench 12 distributed radially and a plurality of grooves 13 surrounded the convex 11.

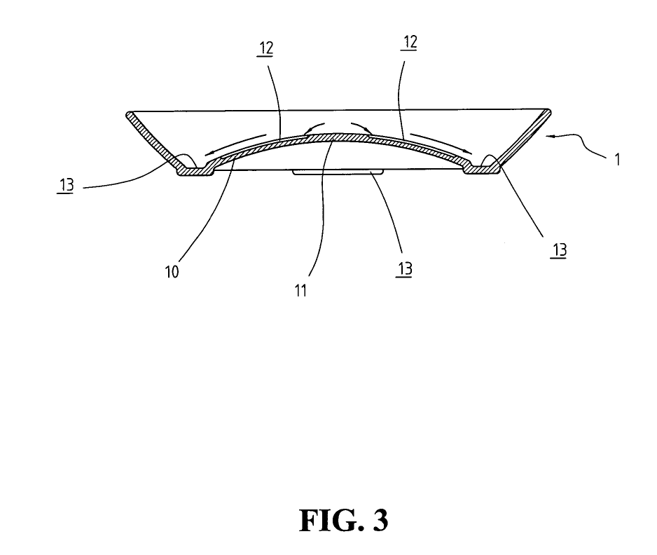

In the first embodiment, the container 1 is a dish structure which is integrative shaping, and the dish bottom 10 has the convex 11 which is curved and protruded showed as FIG. 3 and is formed as a dome. The grooves 13 of dish bottom 10 are caved at the bottom of the container 1, and the grooves 13 are used as supporter for the container 1.

Referring to FIG. 3, because of height difference of the convex 11, some liquid on an upper surface of the convex 11 of the dish bottom 10 flows into the grooves 13 along the arrow showed in the FIG. 3 while hydrous food is put on the container 1. Besides, some other liquid flows into the grooves 13 by guiding of the trenches 12. Therefore, the liquid and food on the container 1 are separated.

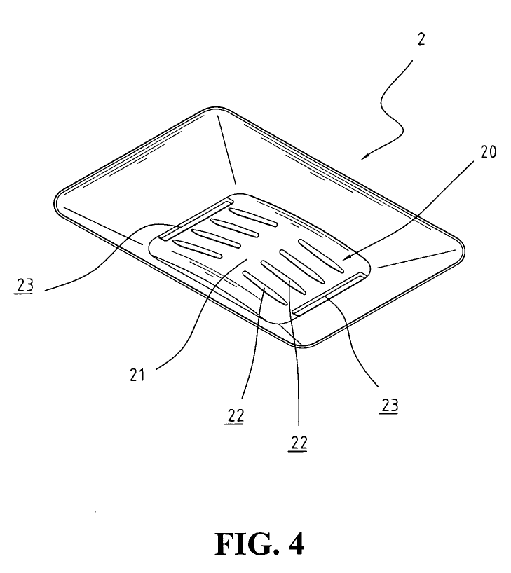

FIG. 4 shows a second embodiment of the container structure of the present invention, of which the difference from the first embodiment is that a container notated 2 is rectangular. Lower of the container 2 is a dish bottom 20 with a convex 21 which is vaulted and spanned form one side to another side of the container 2, and the container 2 has a plurality of grooves 23 formed at these two sides of the convex 21. Moreover, the dish bottom 20 has a plurality of trenches 22 on the upper surface of the convex 21, and each of the trenches 22 is extended longitudinally.

Like the first embodiment, in the second embodiment, some liquid on an upper surface of the convex 21 of the dish bottom 20 flows into the grooves 23 while hydrous food is put on the container 2. Besides, some other liquid flows into the grooves 23 by guiding of the trenches 22. Therefore, the liquid and food on the container 2 are separated.

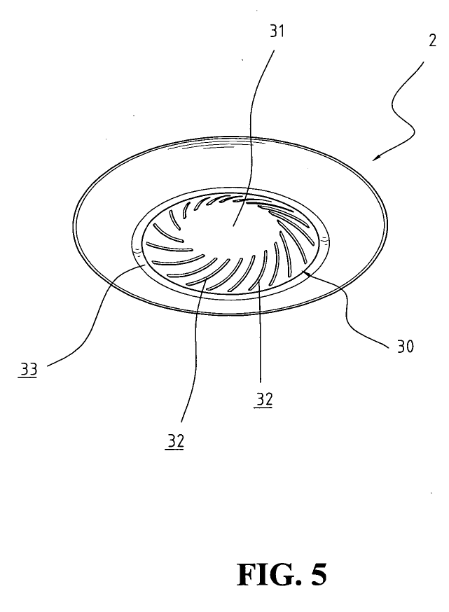

FIG. 5 shows a third embodiment of the container structure of the present invention, of which the difference from the first embodiment is that a container 3 has a groove 33 which is formed circumferentially on a surface of a dish bottom 30 thereof. The dish bottom 30 is at lower of the container 3 and has a convex 31, a curved surface which has a higher part at center and has lower part at circumference thereof. Moreover, the container 3 has a plurality of trenches 32 on the upper surface of the convex 31 of the dish bottom 30. The trenches 32 are distributed radially, and furthermore are formed as a whirlpool.

Like the first embodiment, in the third embodiment, some liquid on an upper surface of the convex 31 of the dish bottom 30 flows into the groove 33 while hydrous food is put on the container 3. Besides, some other liquid flows into the groove 33 by guiding of the trenches 32. Therefore, the liquid and food on the container 3 are separated.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A container structure, comprising:
a container formed as a dish structure, comprising:
a dish bottom being a bottom of the container and forming a convex, the convex having a plurality of trench distributed radially and a plurality of grooves surrounding the convex;
wherein the convex of the dish bottom has height difference so that liquid flows along the convex into the grooves of the dish bottom.

2. The container structure as claimed in claim 1, wherein the container is integrative shaping.

3. The container structure as claimed in claim 1, wherein the a dish bottom is formed as a dome

4. The container structure as claimed in claim 1, wherein the grooves of dish bottom are caved at the bottom of the container, and the grooves are used as supporter for the container.

5. The container structure as claimed in claim 1, wherein the container is rectangular and the convex is vaulted and spanned form one side to another side of the container; and the grooves are formed at these two sides of the convex.

6. The container structure as claimed in claim 1, wherein the container has a groove formed circumferentially on the convex and has a plurality of trenches are distributed radially.

7. The container structure as claimed in claim 6, wherein the trenches are formed as a whirlpool.
